(19) United States
(12) Patent Application Publication
(10) Pub. No.: US 2008/0016553 A1
(43) Pub. Date: Jan. 17, 2008

(54) COMPUTER SECURITY CONTROL METHOD BASED ON USB FLASH DISK

(75) Inventors: YUHONG LIU, Beijing (CN); Hong Peng, Beijing (CN); Yuguang Yang, Beijing (CN)

Correspondence Address: DICKSTEIN SHAPIRO LLP, 1177 AVENUE OF THE AMERICAS (6TH AVENUE), NEW YORK, NY, 10036-2714, US

(73) Assignee: LENOVO (BEIJING) LIMITED, Beijing (CN)

(21) Appl. No.: 11/776,279

(22) Filed: Jul. 11, 2007

(30) Foreign Application Priority Data
Jul. 11, 2006 (CN) 200610101796.5

(51) Int. Cl. H04L 9/32; G06F 7/04

(52) U.S. Cl. 726/3; 726/19

(57) ABSTRACT

The present invention provides a computer security control method based on USB flash disk, in which a log-on password is provided in both of the USB flash disk and the operating system, and the USB flash disk interacts with the computer via USB interface. Said method comprises steps of: step A, starting up the operating system and entering a state of waiting for user log-on; and step B, in the case of normally plugging the USB flash disk in the USB interface, reading the password for logging on the operating system from the USB flash disk, comparing it with the password for logging on the operating system in the operating system, and logging on the operating system if the two passwords are identical. With the method proposed by the present invention, it is possible to realize authentication and management for automatic operating system log-on, private folder opening and network service log-on and then enhance the confidentiality of personal information.

### BACKGROUND OF THE INVENTION

1. Field of Invention

The present invention relates to computer technology, in particularly to a computer security control method based on USB flash disk.

2. Description of Prior Art

With ever wider application of the computer and rapid development of computer technology, a growing number of tasks need to be fulfilled with the computer in the present information society, and the computer has been utilized to store and process an increasing amount of information related to various enterprises, corporations and personal information. An enterprise, a corporation or a person may not want other enterprise, corporation or person to obtain some information stored in the computer, since the obtaining of such information by others may bring about a severe results and lead to a huge loss. In this context, the confidentiality of the information stored in the computer has drawn more and more attention from enterprises, corporations as well individuals.

In order to prevent the information stored in the computer from being acquired by others, there are currently several security management measures as follows.

1) In order to prevent others from illegally using the computer and acquiring the data stored therein, a password verification process is prompt at the start-up of the computer. Typically, a dialogue box for inputting a user's log-on password pops up before the computer enters the operating system to ask the user to input associated log-on password. In addition, the user can put the computer into a locked state when leaving the computer, and the associated log-on password must be entered if any other personal wants to manipulate the computer under the locked state. Furthermore, the user may make such setting that the computer enters the standby or screen-protecting state automatically within a predetermined period of time after the departure of the user. In this case, the associated log-on password is also required if any other personal wants to operate the computer.

2) In addition to impose a security control on the computer, internal data of the computer needs to be further encrypted, especially in the case of multiple individuals sharing one computer. For example, password can be set for data, such as documents and the like, and only a user who knows and entered the proper password can obtain the information stored in the computer.

Since the above schemes prevent others from acquiring data inside the computer in such a simple manner of setting a password, and the set password is subjected to be decrypted by various existing decryption software, the purpose of secrecy cannot be substantially achieve in a sense.

A method called “Verification Method Based on Storage Medium Private Space of USB Flash Disk” is disclosed in Chinese Patent Application No.03137109.4 filed on Jun. 13, 2003. According to the verification method proposed by the application, the control of the user log-on and the close of the operating system as well as the encryption and decryption of a file are realized with USB flash disk and associated security software in the computer.

There are some problems in the above method, however.

1) Since a user can enter the operating system only after inputting an associated password manually, and the locked system can be unlocked only when the associated password is inputted manually, the operation becomes complicated for the user.

2) There is no management mechanism for files to be encrypted except general encryption and decryption process for a file.

3) No differential handling approach is provided for the case of multiple individuals sharing one computer, and different users are not provided with their own private space. Therefore, the same content will be presented to each of the users after he or she logs on the operating system, and the confidentiality of personal information is degraded in this case.

### SUMMARY OF THE INVENTION

The object of the present invention is to provide a computer security control method based on USB flash disk.

According to the first aspect of the present invention, a computer security control method based on USB flash disk is proposed, in which a log-on password is provided in both of the USB flash disk and the operating system, and the USB flash disk interacts with the computer via USB interface. Said method comprises steps of:

Step A: starting up the operating system and entering a state of waiting for user log-on; and

Step B: in the case of normally plugging the USB flash disk in the USB interface, reading the password for logging on the operating system from the USB flash disk, comparing it with the password for logging on the operating system in the operating system, and logging on the operating system if the two passwords are identical with each other.

According to the second aspect of the present invention, a computer security control method based on USB flash disk is proposed, in which a private folder password is provided in both of the USB flash disk and the private folder(s) of the operating system, and one or more private folder passwords corresponding to the private folder(s) in the operating system, respectively, are provided in the USB flash disk. Said method comprises steps of: reading the corresponding private folder password from the USB flash disk at the time of opening the private folder after logging on the operating system, and opening the private folder if the read password is identical to the private folder password in the private folder.

According to the third aspect of the present invention, a computer security control method based on USB flash disk is proposed, in which a network service account number is provided in the USB flash disk, and said method comprises steps of:

after the operating system log-on and network service initiation, reading the network service account number from the USB flash disk, transferring it to a network server and then logging on the network service.

The present invention has the following benefits as compared with the prior art.

1) It is possible to realize authentication for automatic operating system log-on, private folder opening and network service log-on by writing in the USB flash disk the log-on password for operating system, the password of opening the private folder as well as the network service account number. Further, it is possible to automatically close the private folder, log off the network service and exit the operating system after the USB flash disk is withdrawn from the USB interface, and hence the security of personal information is effectively guaranteed.

2) Each private folder can be viewed only by the user having the corresponding USB flash disk while remaining invisible to other users of the one and same computer. Therefore, the confidentiality of personal information is enhanced.

### BRIEF DESCRIPTION OF THE DRAWINGS

FIG. 1 is a flowchart of writing a password for associated authentication in USB flash disk as well as storing a password and creating a private folder in the operating system.

FIG. 2 is a flowchart of automatically logging on the operating system by use of USB flash disk.

FIG. 3 is a flowchart for opening a private folder with USB flash disk after the operating system is logged on.

FIG. 4 is a flowchart of logging on network service with USB flash disk after the operating system is logged on.

### DETAILED DESCRIPTION OF PREFERRED EMBODIMENTS

Hereafter, a detailed explanation will be given to the computer security control method based on USB flash disk of the present invention in connection with specific embodiments and figures.

In order to realize the security control method of the present invention, it is necessary to install in the operating system the associated security software, which exchanges information with the USB flash disk via a USB interface. As the key to logging on the operating system, opening the private folder and logging on the network service, the USB flash disk in the invention has private space and normal space. The private space can also be referred to as reserved region, of which the property and content cannot be changed by a user and which serves as a storage region invisible to the user. The normal space is a storage region the user can utilize in a normal manner. With the interaction between the security software and the USB flash disk which has been inserted in the USB interface, it is possible to log on the operating system automatically as well as carry out authentication for opening the private folder, logging on the network service and the like after the operating system is logged on.

In the present invention, a predetermined identification can be provided on the mainboard of the computer. In the above process of installing the security software, the operating system first detects whether the predetermined identification exists on the mainboard and installs the security software if the answer is yes, otherwise prohibits installation of the security software.

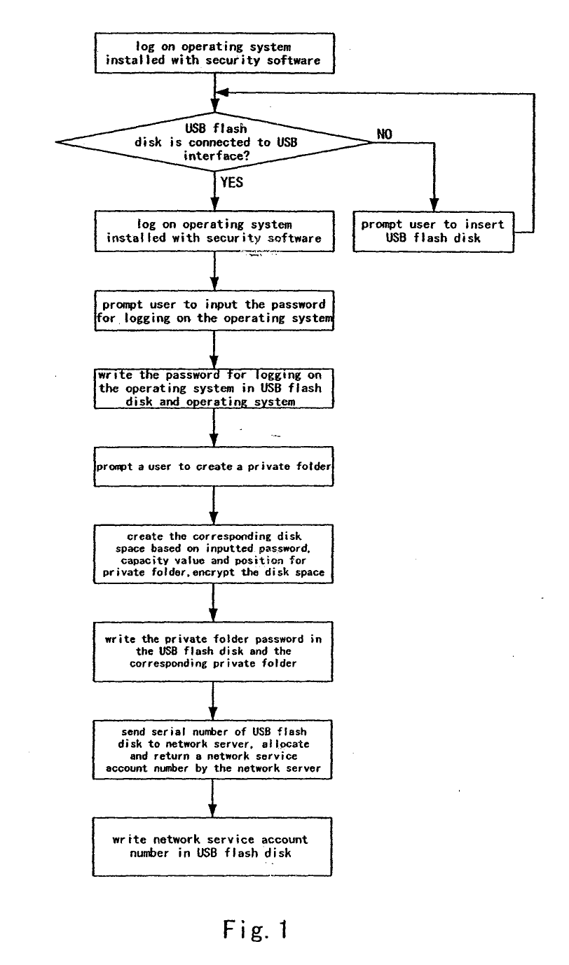

For the purpose of logging on the operating system automatically as well as carrying out authentication for opening the private folder, logging on the network service and the like after the operating system is logged on, the first requirement is to write a password for associated authentication in USB flash disk. It is also necessary to create a private folder, store a password for private folder and a password for logging on the operating system. The detailed process is shown in FIG. 1 and includes the following steps.

At step 100, the operating system installed with the security software is logged on.

At step 110, it is detected by the security software whether there is USB flash disk connected to the USB interface, and if there is, it is proceeded to step 120, otherwise the user is prompted to insert the USB flash disk and proceeding to step 120 after the detection of a normal connection.

At step 120, the user is prompted to input the password for logging on the operating system.

At step 130, the password for logging on the operating system is written in the private space or the normal space of the USB flash disk. The password is preferably written in the private space to ensure its security. The password for logging on the operating system can be further encrypted and then written in the private space of the USB flash disk. The password for logging on the operating system is written in the operating system at the same time of being written in the USB flash disk.

At step 140, the user is prompted to create a private folder. In the present invention, a private folder is a private disk space which is partitioned from a hard disk driver designated by the user and can be opened only with the prescribed password for private folder. Once opened, such space is utilized in the completely identical manner as that for a general disk.

At step 150, the desired password is input, capacity value and location for the private folder by the user, and the corresponding disk space based on the inputted capacity value and location is created by the security software. Besides, the disk space can be further encrypted;

At step 160, the password for private folder is written in the private space or the normal space of the USB flash disk. The password is preferably written in the private space to ensure its security. The password for private folder can be further encrypted and then written in the private space of the USB flash disk. The password for private folder is written in the operating system at the same time of being written in the USB flash disk. The private folder created here is used as the user's confidential private folder, which can be viewed by the user only after the insertion of the USB flash disk storing the password for private folder and the authentication of the password. Each computer may be used to create a plurality of private folders that use the one and same password for private folder or different passwords for private folder.

At step 170, the unique identification of the USB flash disk (e.g., the serial number of the USB flash disk) is further sent to a network server if the user needs to register network service, and a network service account number is allocated and returned by the network server.

At step 180, the network service account number is written in the private space or the normal space of the USB flash disk. The code is preferably written in the private space to ensure its security. The network service account number can be further encrypted and then written in the private space of the USB flash disk. The registration and writing of the network service account number may correspond to a plurality of service.

It will be appreciated that the steps 120-130 for creating the password for logging on the operating system, the steps 140-160 for creating the password for private folder and the steps 170-180 for creating the network service account number may not be executed in the above order, which is merely one example of the execution orders and illustrated for a simple description. Moreover, only certain password can be created in the above steps while other passwords can be established during the subsequent utilization of the USB flash disk.

A predetermined identification indicating the permission to create a password can further be stored in the initial USB flash disk. Such identification is fixed and written in a preset storage space of the USB flash disk, preferably the private space, in the process of manufacturing the USB flash disk by a manufacturer. In this case, it is first checked whether there is such identification in the USB flash disk before the creation of the above password, and the password is created if there is, otherwise the creation of the password is prohibited.

In this way, by storing various passwords for verification in the USB flash disk, it can perform the authentications such as system log-on, private folder opening and network service log-on.

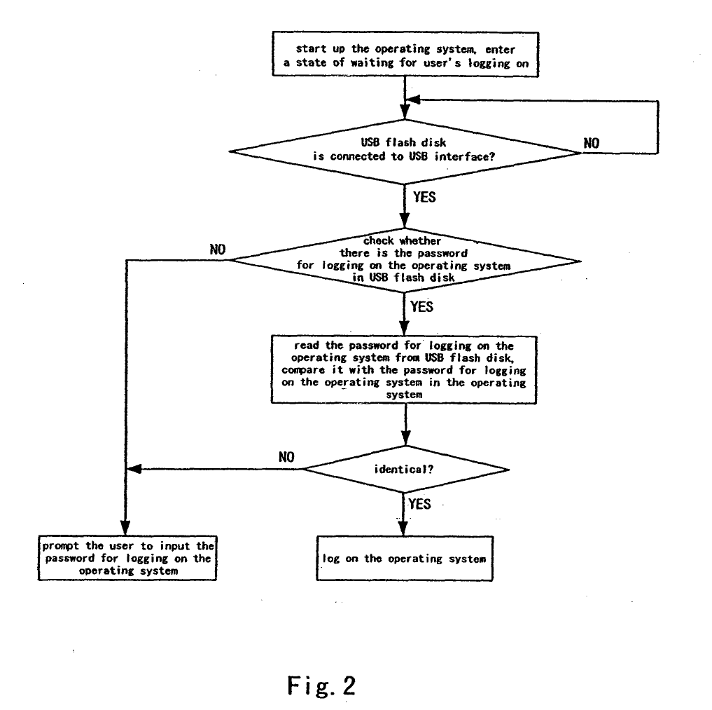

FIG. 2 is a flowchart of automatically logging on operating system by use of the USB flash disk. As shown in FIG. 2, the flow comprises the following steps.

At step 200, the operating system is started up, and a state of waiting for user log on is entered.

At step 210, it is checked whether the USB flash disk has been inserted, if the USB flash disk has been normally plugged in the USB interface, it is proceeded to step 220, and if no USB flash disk is inserted in the USB interface, the user is prompted to insert the USB flash disk and then proceeding to step 220, on the other hand, the user is prompted to input the password for logging on the operating system and logging on the operating system after the user has input the correct password for operating system.

At step 220, it is checked whether there is the password for logging on the operating system in the USB flash disk, if there is, the password for logging on the operating system is read from the USB flash disk, it is compared with the password for logging on the operating system in the operating system, and the operating system is logged on if the two passwords are identical, otherwise the user is prompted to input the password for logging on the operating system so as to log on the operating system. If the password has been encrypted and then written in the USB flash disk, the read password for logging on the operating system must be decrypted before compared with the password for logging on the operating system in the operating system. If there is no password for logging on the operating system in the USB flash disk, the user is prompted to input the password for logging on the operating system so as to logging on the operating system.

After logging on the operating system, the security software checks in real-time way whether the USB flash disk has been plugged out from the USB interface and puts the computer into the state of waiting for user log on if the USB flash disk has been pull out from the USB interface.

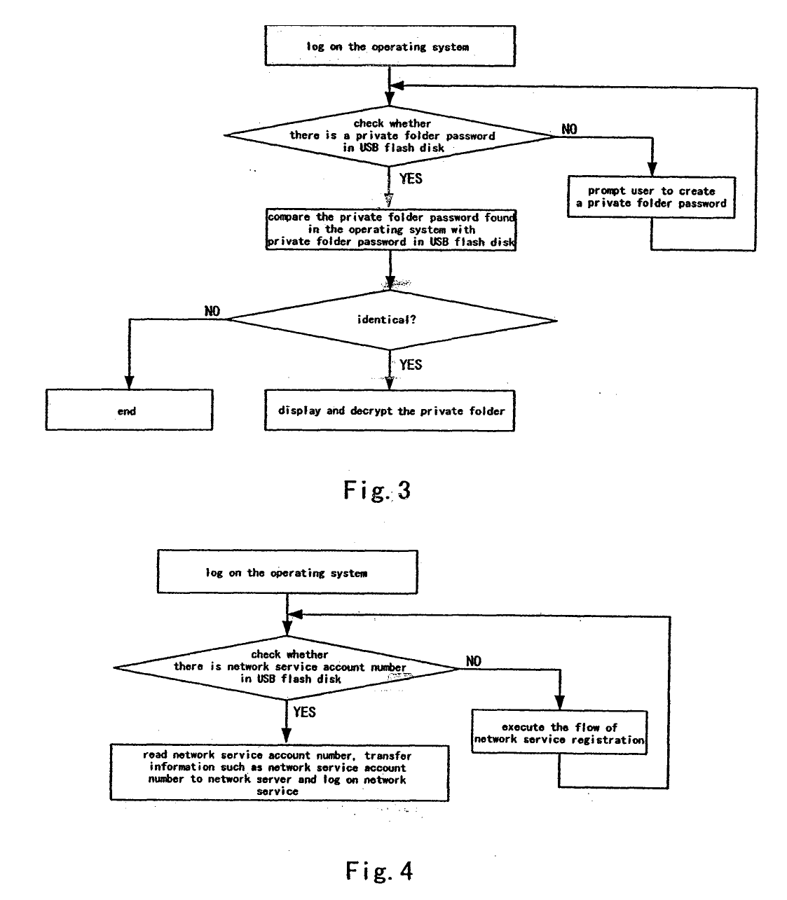

FIG. 3 is a flowchart for opening a private folder with USB flash disk after the operating system is logged on. As shown in FIG. 3, the flow includes the following steps.

At step 300, it checked whether there is a private folder password in the USB flash disk when the user opens a private folder.

At step 310, it is proceeded to step 320 if there is, otherwise the steps for creating a private folder (the steps 140-160 in FIG. 1) is executed and it is returned to step 300 after the creation of the private folder;

At step 320, the private folder password in the USB flash disk is read by the security software while opening the private folder in the operating system and comparing the private folder passwords in the USB flash disk and the private folder. If the two passwords are identical, it is proceeded to step 330, otherwise terminating the flow. If encrypted, the private folder password written in the USB flash disk must be decrypted at first and then compared with the private folder password in the private folder.

At step 330, the private folder is displayed and decrypted. After that, the user can use the private folder in the same manner as that for a general disk.

After opening the private folder, the security software checks in a real-time fashion whether the USB flash disk has been plugged out from the USB interface and, if the USB flash disk has been plugged out from the USB interface, closes the private folder automatically, encrypts and then hides it in the operating system. Thereafter, the computer enters the state of waiting for user log-on.

FIG. 4 is a flowchart for logging on network service with USB flash disk after logging on the operating system. As shown in FIG. 4, this flow includes the following steps.

Step 400, it is checked whether there is a network service account number in the USB flash disk after the user initiates network service.

At step 410, the network service account number is read, and information is transferred, such as the network service account number, to a network server and the network service is logged on if the network service account number is present in the USB flash disk. Otherwise, the network service registration flow (steps 170-180 in FIG. 1) is executed and it is returned to step 400 after registering the network service and obtaining a network service account number.

After the network service is logged on, the security software checks in a real-time fashion whether the USB flash disk has been plugged out from the USB interface and, if the USB flash disk has been plugged out from the USB interface, logs out the network service automatically. Then, the computer enters the state of waiting for user log-on.

The above operations of private folder opening and network service log-on can be carried out simultaneously. In this case, if the USB flash disk has been plugged out from the USB interface, the private folder is closed automatically while the network service is logged out.

As can be seen from the above description, the present invention achieves the following effect as compared with the prior art.

1) It is possible to realize automatic authentication for logging on the operating system, opening the private folder and logging on the network service by writing in the USB flash disk the log-on password for operating system, the password of opening the private folder as well as the network service account number. Further, it is possible to automatically close the private folder, log off the network service and exit the operating system after the USB flash disk is plugged out from the USB interface, and hence the security of personal information is effectively guaranteed.

2) Each private folder can be viewed only by the user having the corresponding USB flash disk while remaining invisible to other users of the one and same computer. Therefore, the confidentiality of personal information is enhanced.

The above discloses only the preferred embodiment of the present invention and has no intention to limit the scope of the present invention. Any variation or substitution that can be readily envisaged by those skilled in the art should be encompassed in the scope of the invention, which is defined by the appended claims.

1. A computer security control method based on USB flash disk, wherein a password for logging on the operating system is provided in both of the USB flash disk and the operating system of the computer, and the USB flash disk interacts with the computer via USB interface, said method comprises steps of:
step A: starting up the operating system and entering a state of waiting for user log-on; and
step B: in the case of normally plugging the USB flash disk in the USB interface, reading the password for logging on the operating system from the USB flash disk, comparing it with the password for logging on the operating system in the operating system, and logging on the operating system if the two passwords are identical.

2. The method according to claim 1, wherein the password for logging on the operating system provided in both of the USB flash disk and the operating system is created through steps of:
logging on the operating system;
prompting the user to input the password for logging on the operating system when it is detected that the USB flash disk is connected to the USB interface; and
writing the password for logging on the operating system in the USB flash disk and the operating system.

3. The method according to claim 2, wherein the password for logging on the operating system is written in the private space of the USB flash disk.

4. The method according to claim 2, wherein the password for logging on the operating system is encrypted and then written in the USB flash disk and the operating system.

5. The method according to claim 2, wherein the password for logging on the operating system is encrypted and then written in the private space of the USB flash disk.

6. The method according to claim 1, further comprising:
step C: exiting the operating system and entering the state of waiting for user log-on if it is detected that the USB flash disk has been plugged out from the USB interface.

7. The method according to claim 1, wherein a private folder password is provided in both of the USB flash disk and the private folder(s) of the operating system, one or more private folder passwords corresponding to the private folder(s) in the operating system, respectively, are provided in the USB flash disk, and
when the private folder is opened after the operating system is logged on, the private folder is opened if the private folder password read from the USB flash disk is identical to the private folder password in the private folder.

8. The method according to claim 7, wherein the private folder password provided in both of the USB flash disk and the private folder(s) of the operating system is created through steps of:
creating the disk space of the private folder based on the inputted password, capacity value and location of the private folder after the operating system is logged on; and
writing the private folder password in the USB flash disk and the corresponding disk space of the private folder.

9. The method according to claim 7, wherein the private folder password is written in the private space of the USB flash disk.

10. The method according to claim 7, wherein the private folder password is encrypted and then written in the USB flash disk and the operating system.

11. The method according to claim 7, wherein the private folder password is encrypted and then written in the private space of the USB flash disk.

12. The method according to claim 7, further comprising:
closing and hiding the private folder, exiting the operating system and entering the state of waiting for user log-on if it is detected that the USB flash disk has been plugged out from the USB interface.

13. The method according to claim 1, wherein a network service account number is further provided in the USB flash disk, and
after the operating system is logged on and the network service is initiated, the network service account number is read from the USB flash disk, transferred to a network server and then the network service is logged on.

14. The method according to claim 13, wherein said network service account number is created through steps of:
sending the unique identification of the USB flash disk to a network server if network service registration is required after the operating system is logged on; and
writing the network service account number allocated by the network server in the USB flash disk.

15. The method according to claim 14, wherein the network service account number is written in the private space of the USB flash disk.

16. The method according to claim 14, wherein the network service account number is encrypted and then written in the private space of the USB flash disk.

17. The method according to claim 13, further comprising:
logging off the network service, exiting the operating system and entering the state of waiting for user log-on if it is detected that the USB flash disk has been plugged out from the USB interface.

18. A computer security control method based on USB flash disk, wherein a private folder password is provided in both of the USB flash disk and the private folder(s) of the operating system, and one or more private folder passwords corresponding to the private folder(s) in the operating system, respectively, are provided in the USB flash disk, said method comprises steps of:
reading the private folder password from the USB flash disk when the private folder is opened after the operating system is logged on, and opening the private folder if the read private folder password is identical to the private folder password in the private folder.

19. The method according to claim 18, wherein the private folder password provided in both of the USB flash disk and the private folder(s) of the operating system is created through steps of:
creating the disk space of the private folder based on the inputted password, capacity value and location of the private folder after the operating system is logged on; and
writing the private folder password in the USB flash disk and the corresponding disk space of the private folder.

20. The method according to claim 19, wherein the private folder password is written in the private space of the USB flash disk.

21. The method according to claim 19, wherein the private folder password is encrypted and then written in the USB flash disk and the operating system.

22. The method according to claim 19, wherein the private folder password is encrypted and then written in the private space of the USB flash disk.

23. The method according to claim 18, further comprising:
closing and hiding the private folder if it is detected that the USB flash disk has been plugged out from the USB interface.

24. A computer security control method based on USB flash disk, wherein a network service account number is provided in the USB flash disk, and said method comprises steps of:
after the operating system log-on and network service initiation, reading the network service account number from the USB flash disk, transferring it to a network server and then logging on the network service.

25. The method according to claim 24, wherein said network service account number is created through steps of:
sending the unique identification of the USB flash disk to a network server if network service registration is required after the operating system is logged on; and
writing the network service account number allocated by the network server in the USB flash disk.

26. The method according to claim 25, wherein the network service account number is written in the private space of the USB flash disk.

27. The method according to claim 25, wherein the network service account number is encrypted and then written in the private space of the USB flash disk.

28. The method according to claim 24, further comprising:
logging off the network service if it is detected that the USB flash disk has been plugged out from the USB interface.
